(19) United States
(12) Patent Application Publication
(10) Pub. No.: US 2012/0161668 A1
(43) Pub. Date: Jun. 28, 2012

(54) LED Driving Circuit

(75) Inventors: Charles Chang, Hsinchu County (TW); Ronald Chang, Hsinchu County (TW)

(73) Assignee: HANERGY TECHNOLOGIES, INC., Hsinchu County (TW)

(21) Appl. No.: 13/331,488

(22) Filed: Dec. 20, 2011

(30) Foreign Application Priority Data
Dec. 24, 2010 (TW) 099145950

(51) Int. Cl. H05B 37/02; G05F 1/10

(52) U.S. Cl. 315/307; 323/282

(57) ABSTRACT

An LED driving circuit is provided in the present invention. The driving circuit includes a load; a control module providing a control signal for regulating a current flowing through the load; a first NMOS; and a first resistor coupled with the control module in parallel so as to generate a clamp voltage providing to the control module.

### FIELD OF THE INVENTION

The present invention relates to a driving circuit, in particular to a driving circuit used for driving light emitting diode.

### BACKGROUND OF THE INVENTION

The light emitting diode (LED) is invented for a long time. Initially, the LED is often used as a red indication light. Gradually, with the development and the grown of the relevant technology, more and more colorful LEDs such as yellow, orange, green and the latest invented blue light LED are invented and used and the application fields thereof are widely expanded. The application field of the LED includes traffic indicating light field, car light field, wall light (scenario light) field and television back light module field etc.

The light emitting diode (LED) is a stable light emitting source and consists of a p-type semiconductor material and a n-type semiconductor material. A photon is generated from transform an electrical current passing through a p-n junction where the p-type and n-type semiconductor materials are joined together during the electrical current is being applied to the p-type and n-type semiconductor materials. It means that once the electrical current is raised, the brightness the LED emits is correspondingly increased. Thus the brightness of the LED can be adjusted via adjusting the electrical current applied thereto. By providing stable electrical current to the LED, the lighting intensity and color for the LED can also be well and precisely controlled.

It is noted that since the specified light wave length emitted from the LED is associated with the specified driving electrical current fed to the LED, when the driving current is different from the specified current, the light wave length is correspondingly changed. Thus, how to effectively control the magnitude for the driving electrical current to the LED and enhance the driving speed is a critical issue nowadays.

For the circumstance that the electrical current demanded for lighting up an LED is low, for example, lesser than 20 mA, it is relatively easy to drive a single LED or multiple LEDs which does not require considering the power loss. The driving circuit is simply composed of a simple linear regulator or limiting current resistor. The limiting current resistor is used for preventing the LED from burning down by the excess electrical current. However, usually a high efficiency switch regulating electrical circuit is utilized in such simple driving circuit to avoid power loss or heat generation, which largely increases the overall cost for making such driving circuit. Furthermore, the LEDs in such driving circuit are typically configured in parallel, which renders the variation range of the driving voltage increasing and raises the degree of difficulty in circuit design.

Please refer to FIG. 1, which is a diagram illustrating a first type conventional driving circuit for LED. The LED driving circuit 10 in FIG. 1 includes an operational amplifier (OP) 11, an NMOS 12, a resistor (R) 13 and an LED 14, where a reference voltage source (VREF) 15 with a duty cycle characteristic is fed to the operational amplifier 11. The driving current I to the LED 14 can be obtained from calculating generateulan i=VREF/R. An important driving characteristic for the driving circuit is its light regulating capability. The adjustment of brightness for the LED 14 is achieved by adjusting the current cycle with on and off higher than 60 Hz. The brightness for the LED 14 is determined by the electrical current passing through the LED 14 that current is switched on and off by the output voltage from the operational amplifier 11 on the basis of the duty cycle of the reference voltage source 15. In order to achieve a dynamic range of high brightness, a driving circuit that can cause a high excitement for LED 14 is demanded. As shown in FIG. 1, the scheme to vary the reference voltage source 15 utilizing the driving circuit 10 architecture therein so as to driving the LED 14 is a conventional approach. However, since the operational amplifier 11 fails to drive the NMOS 12 under off-state configuration, the overall driving speed for the driving circuit 10 is largely slow and the operating point for the operational amplifier 11 has significant drifting effect.

In order to overcome the above-mentioned defect, as shown in FIGS. 2(a) and 2(b), which are the schematic diagrams illustrating a second type conventional driving circuit for LED in an on-state configuration and an off-state configuration respectively, in which a driving circuit with additional switches is proposed. Please refer to FIG. 2(a), the driving circuit 10 is operated under an ordinary mode under an normal on-state configuration. As shown in FIG. 2(b), under an off-state configuration, although the voltage at the gate of the NMOS 12 in the driving circuit 10 is quickly pulled down by the switch 15, the feedback voltage from another feedback circuit for the operational amplifier 11 can still be maintained the same which is achieved by a feedback circuit consisting of the switch 16. Therefore, undoubtedly the second type driving circuit is capable of providing a faster transition speed between on-state and off-state than that of the first type driving circuit.

However, although the feedback circuit for the operational amplifier 11 is a closed loop and the feedback voltage thereof is maintained the same in the second type driving circuit, the output voltage of the operational amplifier 11 is still varied, which remains limiting the operating speed for the driving circuit. Therefore, it can yet not satisfy the demands relating to high driving speed for LED for modern electronic products.

Therefore, it is tried to rectify those drawbacks and provide a better driving circuit. The present invention provides an LED driving circuit in order to achieve the foresaid objective.

### SUMMARY OF THE INVENTION

In order to overcome the shortcomings from prior art, the present invention provides a driving method and a corresponding driving circuit for the LED, which can achieve high speed LED excitement and provide a design criterion for similar circuits. The present invention brings tremendous benefits for the LED and the LED relevant device.

The present invention resolves the above-mentioned defects existing in the prior art by adding an additional feedback circuit module into the driving circuit so as to provide a clamp voltage to the operational amplifier in the driving circuit for stabilizing the output voltage outputted from the operational amplifier. The present driving circuit possesses a simple configuration which can reduce the complexity for circuit design and at mean time owns a superior driving capability which can provide a stable electrical current and voltage to LED.

In accordance with one aspect of the present invention, a driving circuit is provided. The driving circuit includes a control module providing a control signal for regulating a current flowing through a load; a first NMOS; and a first resistor coupled with the control module in parallel, wherein the first NMOS and the first resistor jointly generate a clamp voltage to the control module.

In accordance with the second aspect of the present invention, a driving circuit is provided. The driving circuit includes a control module adjusting a current flowing through a load; a first NMOS; and a first resistor coupled with the control module so as to provide a clamp voltage, with the first NMOS, to the control module.

In accordance with the third aspect of the present invention, a driving circuit is provided. The driving circuit includes a control module adjusting a current flowing through a load; and a voltage generator coupled with the control module so as to provide a clamp voltage to the control module.

In accordance with the fourth aspect of the present invention, a method of controlling a driving circuit working under an operating voltage is provided. The method of controlling a driving circuit working under an operating voltage includes providing a clamp voltage being the operating voltage lesser than a threshold value.

Other objects, advantages and efficacy of the present invention will be described in detail below taken from the preferred embodiments with reference to the accompanying drawings, in which:

### BRIEF DESCRIPTION OF THE DRAWINGS

FIG. 1(a) is a diagram illustrating a first type conventional driving circuit for LED.

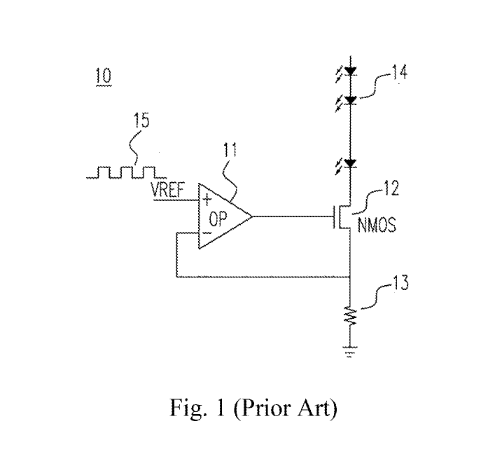

FIGS. 2(a) and 2(b) are the schematic diagrams illustrating a second type conventional driving circuit for LED in an on-state configuration and an off-state configuration respectively.

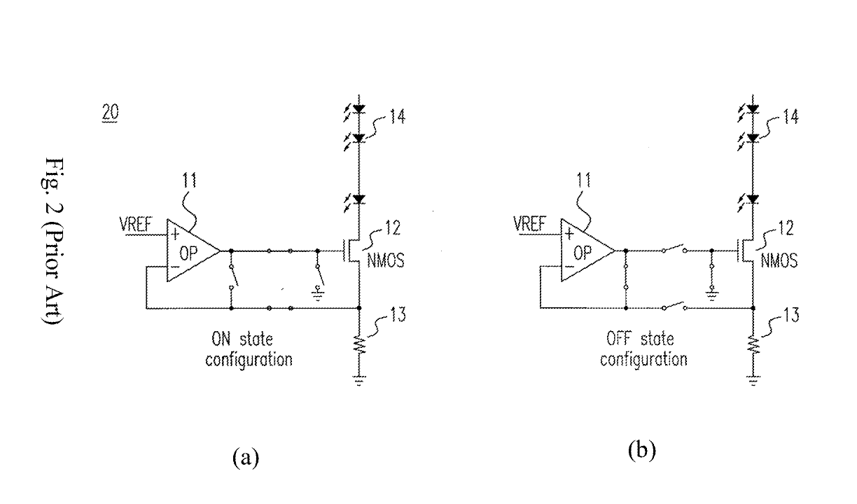

FIG. 3 is the schematic diagram illustrating the driving circuit configurations operated under an on-state configuration according to the present invention.

FIG. 4 is the schematic diagram illustrating the driving circuit configurations operated under an off-state configuration according to the present invention.

### DETAILED DESCRIPTION OF THE PREFERRED EMBODIMENT

The present invention will now be described more specifically to the following embodiments. However, it is to be noted that the following descriptions of preferred embodiments of this invention are presented herein for the purposes of illustration and description only; it is not intended to be exhaustive or to be limited to the precise generate disclosed.

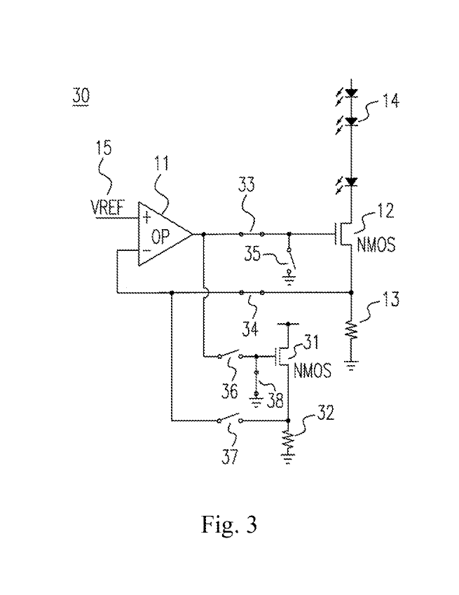

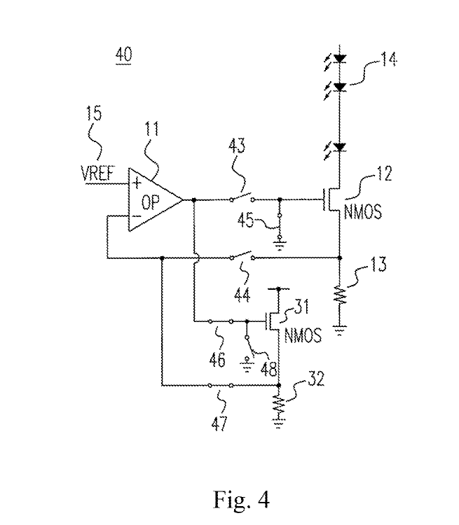

Please refer to FIGS. 3 and 4, which are diagrams respectively illustrating the driving circuit configurations that are operated under an on-state configuration and an off-state configuration respectively according to the present invention. The driving circuit under the on-state configuration 30 in FIG. 3 and under the off-state configuration 40 in FIG. 4 include a first NMOS 31, a second NMOS 12 and an operational amplifier 11. The first NMOS 31 includes a first gate, a first source and a first drain where the first drain is coupled with a power source. The second NMOS 12 includes a second gate, a second source and a second drain, where the second drain is coupled with the load 14 which is preferably an LED. The operational amplifier 11 includes an output end, an non-inverting input end and an inverting input end, wherein the output end is coupled with the first gate and the second gate, the non-inverting input end receives an input reference voltage and the inverting input end is coupled with the first source and a first resistor 32 and is coupled with the second source and a second resistor 13.

Furthermore, the driving circuit in FIGS. 3 and 4 can be divided into three functional circuits, a main circuit, an auxiliary circuit and a feedback circuit. The main circuit is formed by including a first switch 33 and 43, a second switch 34 and 44 and a third switch 35 and 45. The auxiliary circuit is formed by including a fourth switch 36 and 46, a fifth switch 37 and 47 and a sixth switch 38 and 48. The feedback circuit is formed by including the first NMOS 31 and the first resistor 32. During an on-state configuration 30 as shown in FIG. 3, the first switch 33 and the second switch 34 are switched on, the third switch 35 is switched off, the fourth switch 36 and the fifth switch 37 are switched off and the sixth switch 38 is switched on. During an off-state configuration 40 as shown in FIG. 4, the first switch 43 and the second switch 44 are switched off, the third switch 45 is switched on, the fourth switch 46 and the fifth switch 47 are switched on and the sixth switch 48 are switched off

Based on the above-mentioned configuration, since the driving circuit is designed to include the feedback circuit including the first NMOS 31 and the first resistor 32 as compared with the conventional driving circuit, while the driving circuit is switched to the off-state configuration 40 as shown in FIG. 4, the output voltage under the off-state from the operational amplifier 11 will be adjusted by the feedback circuit and can be maintained same as that under the on-state due to the adjustment from the feedback circuit.

Therefore, no matter the driving circuit is operated under either the on-state or the off-state, the output voltage from the operational amplifier 11 can be controlled or set to maintain the same by the feedback circuit. At the same time, an operating point for the operational amplifier 11 and a direct current (DC) operating point for the driving circuit can also maintain the same under either the on-state or the off-state. Therefore, the responding period for the driving circuit will become rapid under such a configuration according to the present invention. The first resistor 32 is preferably a resistor with greater resistive value which can reduce an electrical current loss for the load under the off-state.

Moreover, since the present invention can suppress the oscillation of the output voltage from the operational amplifier 11 resulted from being frequently switched between on and off, the heat generation resulted from the oscillation for the driving circuit is significantly reduced, and the electromagnetic interference (EMI) resulting from the driving circuit and the anti-EMI capability for the driving circuit is correspondingly decreased and enhanced respectively.

There are further Embodiments provide as follows:

### Embodiment 1

A driving circuit includes a control module providing a control signal for regulating a current flowing through a load; a first NMOS; and a first resistor coupled with the control module in parallel, wherein the first NMOS and the first resistor jointly generate a clamp voltage to the control module.

### Embodiment 2

The driving circuit according to Embodiment 1, wherein the first NMOS has a turn-on resistance and includes a first gate, a first source and a first drain and the first drain is coupled to an external voltage source, further includes a second NMOS having a second gate, a second source and a second drain, wherein the second drain is coupled with the load; a second resistor; and an operational amplifier having an output end, an non-inverting input end and an inverting input end, wherein the output end is coupled with the first gate and the second gate, the non-inverting input end receives an input reference voltage and the inverting input end is coupled with the first source, the first resistor, the second source and the second resistor.

### Embodiment 3

The driving circuit according to Embodiment 2, further includes a main circuit having a first switch, a second switch and a third switch for providing the control signal during an on-state; and an auxiliary circuit coupled with the main circuit and having a fourth switch, a fifth switch and a sixth switch for providing a constant voltage the same as that during an off-state to the operational amplifier during the on-state, wherein the first switch and the second switch are turned on, the third switch is turned off, the fourth switch and the fifth switch are turned off and the sixth switch is turned on during the on-state, and the first switch and the second switch are turned off, the third switch is turned on, the fourth switch and the fifth switch are turned on and the sixth switch is turned off during the off-state.

### Embodiment 4

The driving circuit according to Embodiment 2, wherein the second NMOS provides a driving current having a magnitude that is a ratio of the input reference voltage over a resistance of the second resistor and is greater than what the clamp voltage demands, for reducing a current loss for the load.

### Embodiment 5

The driving circuit according to Embodiment 2, wherein the operational amplifier has an input voltage with a direct current operating point and an output voltage that is determined via regulating the turn-on resistance and the first resistor during the off-state.

### Embodiment 6

The driving circuit according to Embodiment 5, wherein the direct current operating point and the output voltage maintain stability during one of an on-state and the off-state.

### Embodiment 7

The driving circuit according to Embodiment 1, wherein the first NMOS and the first resistor generate a feedback circuit during an off-state.

### Embodiment 8

The driving circuit according to Embodiment 1, wherein the load is an LED light source.

### Embodiment 9

A driving circuit includes a control module adjusting a current flowing through a load; a first NMOS; and a first resistor coupled with the control module so as to provide a clamp voltage, with the first NMOS, to the control module.

### Embodiment 10

A driving circuit includes a control module adjusting a current flowing through a load; and a voltage generator coupled with the control module so as to provide a clamp voltage to the control module.

### Embodiment 11

The driving circuit according to Embodiment 10, wherein the voltage generator includes a first NMOS having a turn-on resistance; and a first resistor, wherein the first NMOS and the first resistor are coupled with the control module in parallel so as to jointly generate a clamp voltage to the control module.

### Embodiment 12

A method of controlling a driving circuit working under an operating voltage includes providing a clamp voltage being the operating voltage lesser than a threshold value.

### Embodiment 13

The method according to Embodiment 12, wherein the driving circuit includes a control module providing a control signal for regulating a current flowing through a load; a first NMOS; a first resistor coupled with the control module in parallel so as to generate the clamp voltage, with the first NMOS, to the control module; a second NMOS having a second gate, a second source and a second drain coupled with the load; an operational amplifier having an output end coupled with the first gate and the second gate, an non-inverting input end receiving an input reference voltage and an inverting input end coupled with the first source, the first resistor, the second source and a second resistor; a main circuit having a first switch, a second switch and a third switch for providing the control signal during an on-state; and an auxiliary circuit coupled with the main circuit and having a fourth switch, a fifth switch and a sixth switch for providing a constant voltage during the on-state being the same as that provided to the operational amplifier during an off-state, wherein the method further includes the steps of causing the first switch and the second switch to be turned on, the third switch to be turned off, the fourth switch and the fifth switch to be turned off and the sixth switch to be turned on during the on-state; and causing the first switch and the second switch to be turned off, the third switch to be turned on, the fourth switch and the fifth switch to be turned on and the sixth switch to be turned off during the off-state.

### Embodiment 14

The method according to Embodiment 13, wherein the clamp voltage is generated by a combination of the first NMOS and the first resistor.

To sum up, the present driving circuit for exciting LED provides a clamp voltage generated by the auxiliary circuit and the feedback circuit to operational amplifier so as to ensure the output of the operational amplifier is maintained at a high and specific level, even during an off-state configuration, such that the driving speed and the stability of the electrical driving current and voltage for the driving circuit is greatly enhanced. The present invention is particularly suitable for but not limited to being adopted in, for example, an LED backlight module in television and occasions demanding high speed driving.

Based on the above descriptions, while the invention has been described in terms of what are presently considered to be the most practical and preferred embodiments, it is to be understood that the invention should not be limited to the disclosed embodiment. On the contrary, it is intended to cap numerous modifications and variations included within the spirit and scope of the appended claims which are to be accorded with the broadest interpretation so as to encompass all such modifications and variations. Therefore, the above description and illustration should not be taken as limiting the scope of the present invention which is defined by the appended claims.

What is claimed is:

1. A driving circuit, comprising:
a control module providing a control signal for regulating a current flowing through a load;
a first NMOS; and
a first resistor coupled with the control module in parallel, wherein the first NMOS and the first resistor jointly generate a clamp voltage to the control module.

2. The driving circuit according to claim 1, wherein the first NMOS has a turn-on resistance and includes a first gate, a first source and a first drain and the first drain is coupled to an external voltage source, further comprising:
a second NMOS having a second gate, a second source and a second drain, wherein the second drain is coupled with the load;
a second resistor; and
an operational amplifier having an output end, an non-inverting input end and an inverting input end, wherein the output end is coupled with the first gate and the second gate, the non-inverting input end receives an input reference voltage and the inverting input end is coupled with the first source, the first resistor, the second source and the second resistor.

3. The driving circuit according to claim 2, further comprising:
a main circuit having a first switch, a second switch and a third switch for providing the control signal during an on-state; and
an auxiliary circuit coupled with the main circuit and having a fourth switch, a fifth switch and a sixth switch for providing a constant voltage the same as that during an off-state to the operational amplifier during the on-state,
wherein the first switch and the second switch are turned on, the third switch is turned off, the fourth switch and the fifth switch are turned off and the sixth switch is turned on during the on-state, and the first switch and the second switch are turned off, the third switch is turned on, the fourth switch and the fifth switch are turned on and the sixth switch is turned off during the off-state.

4. The driving circuit according to claim 2, wherein the second NMOS provides a driving current having a magnitude that is a ratio of the input reference voltage over a resistance of the second resistor and is greater than what the clamp voltage demands, for reducing a current loss for the load.

5. The driving circuit according to claim 2, wherein the operational amplifier has an input voltage with a direct current operating point and an output voltage that is determined via regulating the turn-on resistance and the first resistor during the off-state.

6. The driving circuit according to claim 5, wherein the direct current operating point and the output voltage maintain stability during one of an on-state and the off-state.

7. The driving circuit according to claim 1, wherein the first NMOS and the first resistor generate a feedback circuit during an off-state.

8. The driving circuit according to claim 1, wherein the load is an LED light source.

9. A driving circuit, comprising:
a control module adjusting a current flowing through a load;
a first NMOS; and
a first resistor coupled with the control module so as to provide a clamp voltage, with the first NMOS, to the control module.

10. A driving circuit, comprising:
a control module adjusting a current flowing through a load; and
a voltage generator coupled with the control module so as to provide a clamp voltage to the control module.

11. The driving circuit according to claim 10, wherein the voltage generator comprises:
a first NMOS having a turn-on resistance; and
a first resistor,
wherein the first NMOS and the first resistor are coupled with the control module in parallel so as to jointly generate a clamp voltage to the control module.

12. A method of controlling a driving circuit working under an operating voltage, comprising:
providing a clamp voltage being the operating voltage lesser than a threshold value.

13. The method according to claim 12, wherein the driving circuit comprises:
a control module providing a control signal for regulating a current flowing through a load;
a first NMOS;
a first resistor coupled with the control module in parallel so as to generate the clamp voltage, with the first NMOS, to the control module;
a second NMOS having a second gate, a second source and a second drain coupled with the load;
an operational amplifier having an output end coupled with the first gate and the second gate, an non-inverting input end receiving an input reference voltage and an inverting input end coupled with the first source, the first resistor, the second source and a second resistor;
a main circuit having a first switch, a second switch and a third switch for providing the control signal during an on-state; and
an auxiliary circuit coupled with the main circuit and having a fourth switch, a fifth switch and a sixth switch for providing a constant voltage during the on-state being the same as that provided to the operational amplifier during an off-state,
wherein the method further comprises the steps of:
causing the first switch and the second switch to be turned on, the third switch to be turned off, the fourth switch and the fifth switch to be turned off and the sixth switch to be turned on during the on-state; and
causing the first switch and the second switch to be turned off, the third switch to be turned on, the fourth switch and the fifth switch to be turned on and the sixth switch to be turned off during the off-state.

14. The method according to claim 13, wherein the clamp voltage is generated by a combination of the first NMOS and the first resistor.
